(19) United States
(12) Patent Application Publication
(10) Pub. No.: US 2019/0297232 A1
(43) Pub. Date: Sep. 26, 2019

(54) DIGITALLY-BASED, THERMAL IMAGING DEVICE CONFIGURED IN A CONVENTIONAL, OPTICALLY-BASED IMAGING DEVICE FORM FACTOR

(71) Applicant: JSC Yukon Advanced Optics Worldwide, Vilnius (LT)

(72) Inventor: Aliaksandr Alsheuski, Vilnius (LT)

(21) Appl. No.: 16/285,652

(22) Filed: Feb. 26, 2019

Related U.S. Application Data
(60) Provisional application No. 62/635,350, filed on Feb. 26, 2018.

(51) Int. Cl. H04N 5/225; G01J 5/10

(52) U.S. Cl. CPC H04N 5/2253; G01J 2005/0077; G01J 5/10

(57) ABSTRACT

A digitally-based, thermal imaging device, comprises a tube-shaped body. Within the tube-shaped is contained a receiving optical sensor, a viewing computer display, and a rechargeable battery. The thermal imaging device also includes a rechargeable battery, an integrated control mechanism turret, and a data transfer interface turret.

### CROSS-REFERENCE TO RELATED APPLICATIONS

This application claims priority to U.S. Provisional Patent Application No. 62/635,350, filed on Feb. 26, 2018, which is hereby incorporated by reference in its entirety.

### BACKGROUND

Imaging devices, such as firearm scopes, are configured into different form factors depending upon whether the imaging device is digitally- or optically-based. Unlike optically-based imaging devices, it is unnecessary for electromagnetic radiation (for example, infrared (IR)) to pass completely through a digitally-based imaging device to be viewed, because the electromagnetic radiation is gathered by an optical sensor, computer-processed, and recreated/displayed on a computer display for viewing. Differing form factors cause inconvenience for users, as mounting systems are different for optically- and digitally-based imaging devices. As a result, it is necessary to change mounting systems to switch between use of a digitally- and optically-based imaging device with respect to a piece of equipment (such as, a firearm or tripod).

### SUMMARY

The present disclosure describes a digitally-based, thermal imaging device configured in a conventional, optically-based imaging device form factor.

In an implementation, a digitally-based, thermal imaging device, comprises a tube-shaped body. Within the tube-shaped is contained a receiving optical sensor, a viewing computer display, and a rechargeable battery. The thermal imaging device also includes a rechargeable battery, an integrated control mechanism turret, and a data transfer interface turret.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, the described digitally-based, thermal imaging device form factor corresponds to conventional optically-based imaging device form factors and permits use of similar (or the same) mounting systems with each imaging device. Second, the use of similar mounting systems allows greater flexibility and interchangeability depending on an imaging device user's particular needs. Third, the described digitally-based, thermal imaging device is configured with a user-replaceable battery (for example, rechargeable or non-rechargeable) to extend allowable time-of-use for the digitally-based, thermal imaging device. Fourth, the described digitally-based, thermal imaging device is configured with an integrated, rotary-type single control mechanism for ease of use. Fifth, the digitally-based, thermal imaging device is configured with computer-based connectivity, including universal serial bus (USB), FIREWIRE, and WIFI, to allow the digitally-based, thermal imaging device to be updated, configured, and to stream video or other data to/from the digitally-based, thermal imaging device.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a schematic diagram illustrating a right-side, cut-away view of an example digitally-based, thermal scope configured in a conventional, optically-based scope form factor, according to an implementation of the present disclosure.

FIG. 2 is a schematic diagram illustrating a top, cut-away view of the example digitally-based, thermal scope of FIG. 1 configured in a conventional, optically-based scope form factor, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes a digitally-based, thermal imaging device configured in a conventional, optically-based imaging device form factor, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Imaging devices, such as firearm scopes, are configured into different form factors depending upon whether the imaging device is digitally- or optically-based. Unlike optically-based imaging devices, it is unnecessary for electromagnetic radiation (for example, infrared (IR)) to pass completely through a digitally-based imaging device (for example, a digitally-based, thermal imaging device) to be viewed, because the electromagnetic radiation is gathered by an optical sensor, computer-processed, and recreated/displayed on a computer display for viewing.

The differing form factors cause inconvenience for users, as mounting systems are different for optically- and digitally-based imaging devices. For example, optically-based imaging devices are typically mounted to equipment (for example, a firearm or tripod) using ring-type mounting devices that fit around the tube-shaped body to secure the imaging device. On the other hand, digitally-based imaging devices are typically mounted to equipment using, for example, threaded screws (such as, ¼″-20) that screw directly into the body of the digitally-based imaging device. As a result, it is necessary to change mounting systems associated with a piece of equipment (such as, a firearm or tripod) to switch between use of a digitally- and optically-based imaging device.

Note, while this disclosure is focused on configurations and functionality associated with a digitally-based imaging device sensitive to thermal electromagnetic radiation (for example, IR), as will be appreciated by those of ordinary skill in the art, the described subject matter is also applicable to implementations of digitally-based imaging devices sensitive to any other type of detectable electromagnetic radiation (for example, ultraviolet (UV) and visible/ambient/daylight). These other implementations are considered to be within the scope of this disclosure.

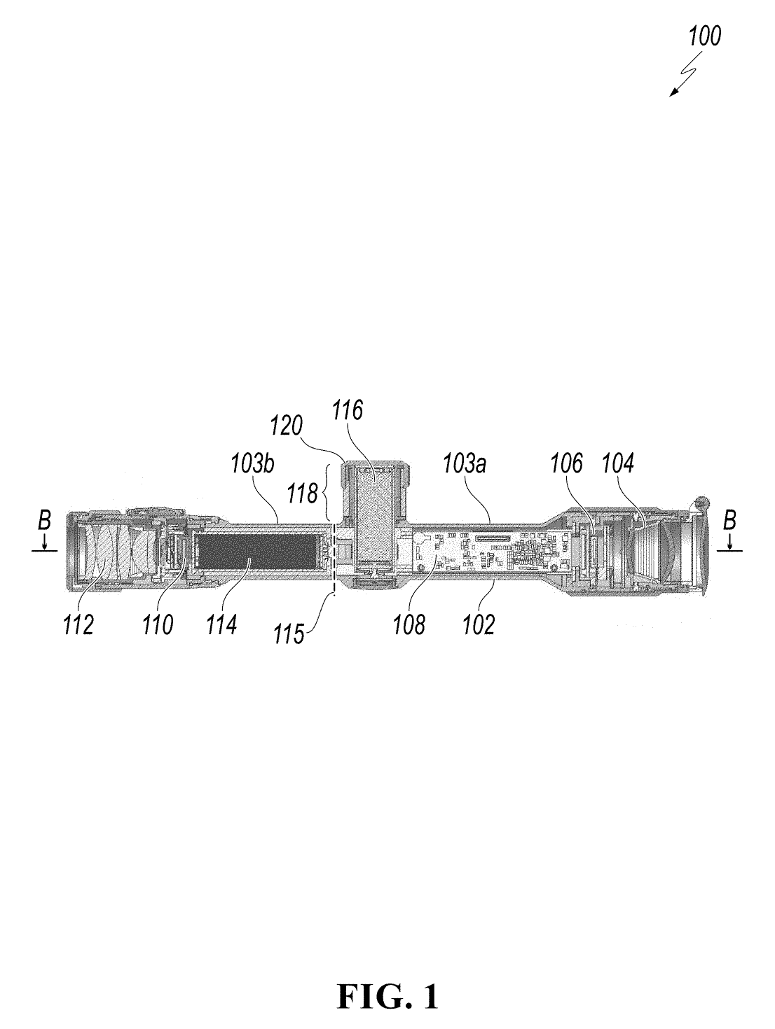

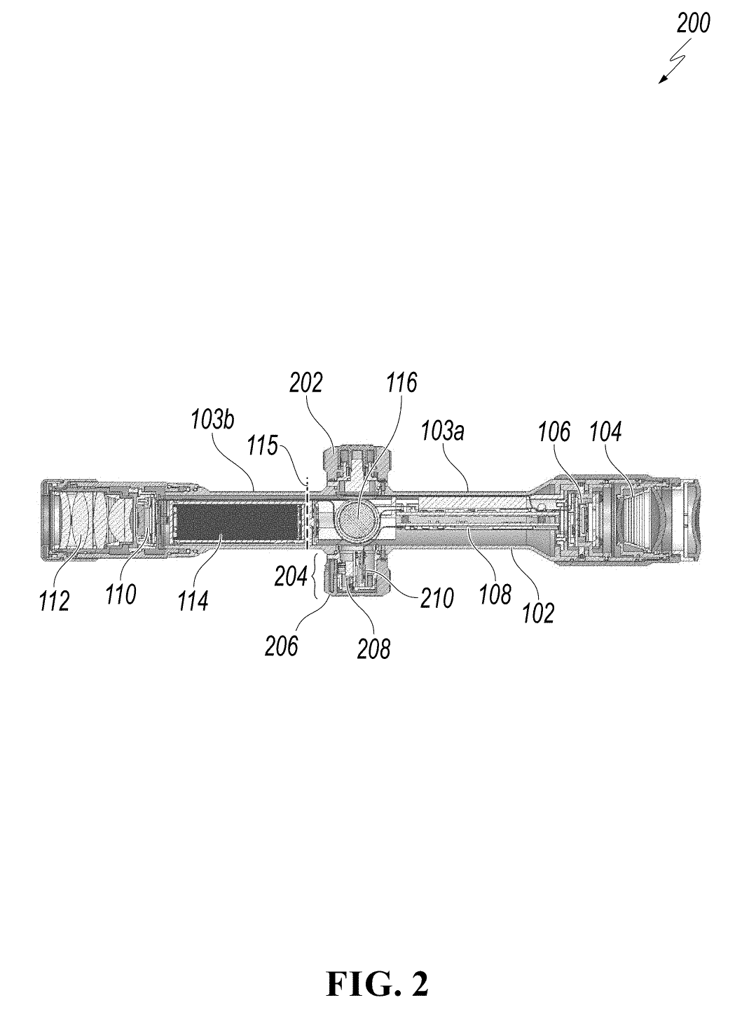

FIG. 1 is a schematic diagram illustrating a right-side, cut-away view 100 of an example digitally-based, thermal scope 101 configured in a conventional, optically-based scope form factor, according to an implementation of the present disclosure. The illustrated digitally-based, thermal scope 101 in FIG. 1 includes a tube-shaped body 102, receiving optics 104, receiving optical sensor 106, processing electronics 108, viewing computer display 110, viewing optics 112, internal rechargeable battery 114, and user-replaceable battery 116 (within battery turret 118 and secured with a removable battery turret cap 120). Refer to FIG. 2 for two additional turret-type assemblies not displayed in FIG. 1 (that is, 202 and 204).

Tube-shaped body 102 is configured to permit mounting on equipment (for example, a firearm or tripod) using mounting systems similar to those used in mounting optically-based imaging devices. For example, the tube-shaped body 102 can be mounted to equipment at approximately positions 103a and 103b using a ring-type mounting system.

At a high-level, receiving optics 104 and receiving optical sensor 106 gather incoming electromagnetic radiation (for example, IR light) for computer processing. Data generated by the receiving optical sensor 106 (for example, a charged coupled device (CCD), complementary metal-oxide-semiconductor (CMOS), or quanta image sensor (QIS)) is processed by processing electronics 108 into image data to be recreated/represented on viewing computer display 110 (for example, a color/monochrome liquid crystal display (LCD) or organic light-emitting diode (OLED) display, or other similar/suitable display) and viewed through viewing optics 112.

Internal rechargeable battery 114 is used to provide power to components and functions associated with the illustrated digitally-based, thermal scope 101. For example, the internal rechargeable battery 114 can be used to power the receiving optical sensor 106, processing electronics 108 (and associated provided functionality), viewing computer display 110, data transfer interfaces (for example, universal serial bus (USB), FIREWIRE, and WIFI), control mechanisms (for example, an integrated, rotary-type single control mechanism described in FIG. 2), and other functions consistent with this disclosure (for example, displaying a reticle on the viewing computer display 110 and wired/wireless integration with a mobile computing device). In some implementations, the internal rechargeable battery 114 can include lead-acid, nickel-cadmium (NiCd), nickel-metal hydride (NiMH), lithium-ion (Li-ion), lithium-ion polymer (Li-ion polymer), or other suitable battery technologies consistent with this disclosure. In some implementations, the internal rechargeable battery 114 can be recharged from power supplied by a data transfer interface (for example, a USB port) or the user-replaceable battery 116. For example, processing electronics 108 can be configured to detect a low-charge state of the internal rechargeable battery 114 and pull power from the user-replaceable battery 116 to charge the internal rechargeable battery 114 to a minimum charge state (if possible).

In some implementations, the digitally-based, thermal scope 101 can be configured to use power from the user-replaceable battery 116 until reaching a minimum charge state, at which point the digitally-based, thermal scope 101 can switch to the internal rechargeable battery 114 (if of a sufficient charge state) or to be gracefully shut down due to lack of power. Once a charged user-replaceable battery 116 is re-installed, the digitally-based, thermal scope 101 can switch power consumption back to the user-replaceable battery 116. The user-replaceable battery 116 can be used to extend allowable time-of-use for the digitally-based, thermal scope 101. For example, a user can hot-swap the user-replaceable battery 116 when discharged with a fresh battery to keep the digitally-based, thermal scope 101 operating. In other implementations, the digitally-based, thermal scope 101 can be configured to use power from the internal rechargeable battery 114 until reaching a minimum charge state, at which point the digitally-based, thermal scope 101 can switch to the user-replaceable battery 116 (if present) or to be gracefully shut down due to lack of power. In some implementations, modes of battery operation (that is, primary and secondary battery usage) can be selectable by a user depending upon their particular needs.

In some implementations, an external power supply could power the digitally-based, thermal scope 101 and recharge the internal rechargeable battery 114 and user-replaceable battery 116 (if rechargeable). For example, the processing electronics 108 can be configured to determine, if external power is available (for example, using a USB port or other external port (not illustrated)) and whether the internal rechargeable battery 114 or user-replaceable battery 116 is in a low-power state. If power is available, power can be directed to recharge the internal rechargeable battery 114 or user-replaceable battery 116. In some implementations, the processing electronics 108 can trigger an indicator (for example, light-emitting diode (LED), audio chirp, viewing computer display 110, or other visual/audio indicator) that the internal rechargeable battery 114 or user-replaceable battery 116 is (or is about to be) discharged or is charging. In some implementations, the processing electronics 108 can be configured to transmit data to a mobile computing device to display a message to a user that the internal rechargeable battery 114 or user-replaceable battery 116 is discharged and needs replacement or is recharging. In some implementations, a rechargeable user-replaceable battery 116 can include lead-acid, nickel-cadmium (NiCad), nickel-metal hydride (NiMH), lithium-ion (Li-ion), lithium-ion polymer (Li-ion polymer), or other suitable battery technologies consistent with this disclosure.

In some implementations, the internal rechargeable battery 114 is not user replaceable and must be replace by an authorized service center. In other implementations, the tube-shaped body 102 can be configured to be separable (for example, at 115) to permit user replacement of the internal rechargeable battery 114. For example, once a rechargeable battery exceeds a certain number of recharge cycles, the battery is incapable of holding a desirable amount of charge. In this case, a user might with to replace the depleted internal rechargeable battery 114. In a particular example, the tube-shaped body 102 could be in two-piece configuration that is screwed together (for example, at 115) once the internal rechargeable battery 114 is installed. In this configuration, the two pieces of the tube-shaped body 102 can be unscrewed, separated, the internal rechargeable battery 114 replaced with a new battery, and the two pieces of the tube-shaped body 102 screwed back together. Other attachment mechanisms for the two pieces of the tube-shaped body 102 that are consistent with this disclosure are considered to be within the scope of this disclosure.

Battery turret 118 is configured to hold the user-replaceable battery 116. The removable battery turret cap 120 is used to secure the user-replaceable battery 116 within the battery turret 118. In some implementations, the user-replaceable battery 116 can be either rechargeable or non-rechargeable and varying form factors, such as a 123A, CR2032, AA, and AAA).

In some implementations, the battery turret cap 120 can be a pop-off, friction fit, or screw-type cap. In some implementations, the battery turret cap 120 can be retained to the digitally-based, thermal scope 101 using a wire loop, elastic band, or other retention mechanism to prevent the battery turret cap 120 from becoming separated from the digitally-based, thermal scope 101. In typical implementations, the battery turret cap 120 (or battery compartment 110) is configured with one or more O-rings or other seals to provide a water- and dust-proof compartment for the user-replaceable battery 116.

In some implementations, processing electronics 108 can also be configured to provide other functionality consistent with this disclosure. For example, processing electronics 108 can be configured to provide WIFI, USB, streaming video, firmware upgrades, connectivity with mobile computing devices, control interfaces, and other functionality consistent with this disclosure associated with the digitally-based, thermal scope 101.

FIG. 2 is a schematic diagram illustrating a top, cut-away view 200 of the example digitally-based, thermal scope 101 of FIG. 1 configured in a conventional, optically-based scope form factor, according to an implementation of the present disclosure. As illustrated in FIG. 2, the digitally-based, thermal scope 101 includes an integrated, push/rotary-type single control mechanism turret (control) 202 and data transfer interface turret 204.

Control 202 can provide integrated control functionality associated with the digitally-based, thermal scope 101. For example, if the digitally-based, thermal scope 101 is powered off, a long push in of a “cap” configured into the control 202 can power on the digitally-based, thermal scope 101 (or conversely power off the digitally-based, thermal scope 101 if powered on). While looking through viewing optics 112 at the viewing computer display 110, rotary- and push-type actions of the control 202 can be used to navigate among displayed graphical user interface menus and select menu items. Any function provided by control 202 that is consistent with this disclosure is considered to be within the scope of this disclosure. In some implementations, a mobile computing device can be integrated with the digitally-based, thermal scope 101 (for example, using WIFI) and provide an interface (for example, with a software application) to permit alternative configuration of the digitally-based, thermal scope 101.

Data transfer interface turret 204 is used to provide data transfer interfaces (for example, USB 208 and WIFI 210) for the digitally-based, thermal scope 101. For example, in conjunction with the processing electronics 108, the described data transfer interface can provide WIFI, USB, streaming video, firmware upgrades, connectivity with mobile computing devices, control interfaces, and other functionality consistent with this disclosure and associated with the digitally-based, thermal scope 101. In some implementations, the data transfer interfaces (for example, USB 208) can be used to provide external power to the digitally-based, thermal scope 101 to power digitally-based, thermal scope 101 functionality or to recharge the internal rechargeable battery 114 or user-replaceable battery 116.

In some implementations, data transfer interface turret 204 is configured with a removable turret cap 206. In some implementations, the turret cap 206 can be a pop-off, friction-fit, or screw-type cap. In some implementations, the turret cap 206 can be retained to the digitally-based, thermal scope 101 using a wire loop, elastic band, or other retention mechanism to prevent the turret cap 206 from becoming separated from the digitally-based, thermal scope 101. In typical implementations, the turret cap 206 (or data transfer interface turret 204) is configured with one or more O-rings or other seals to provide a water- and dust-proof compartment for the associated data transfer interfaces.

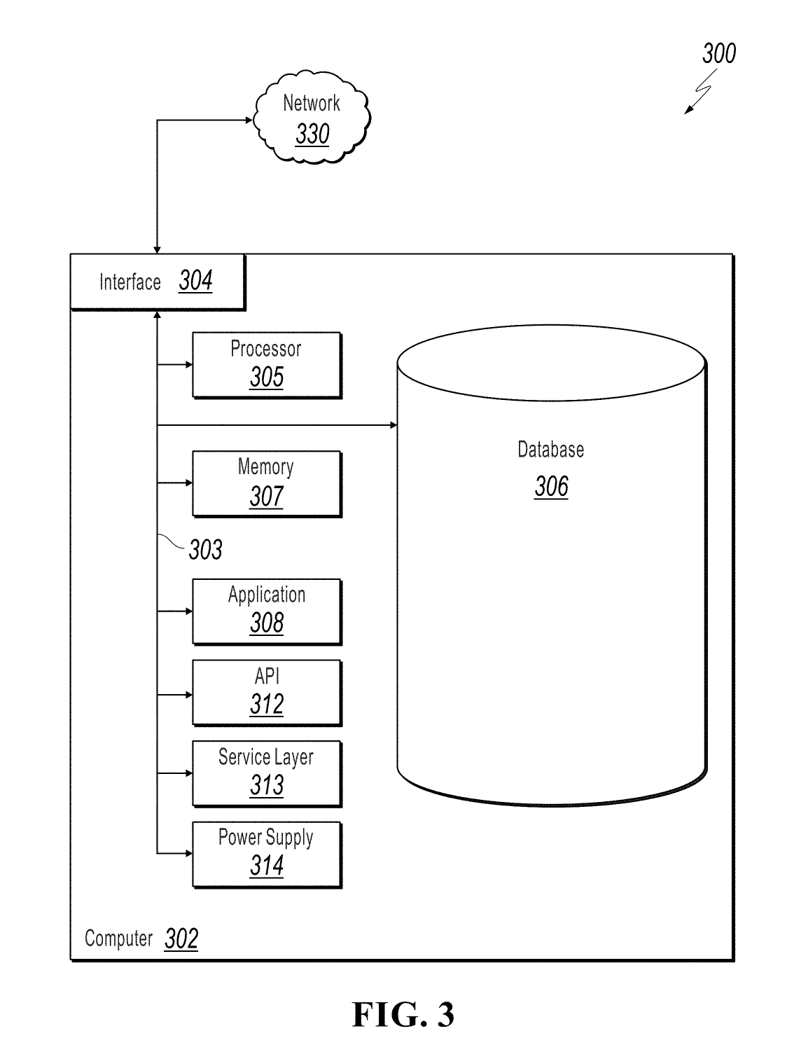

FIG. 3 is a block diagram illustrating an example of a computer-implemented System 300 (for example, representing or as part of processing electronics 108) used to provide computational functionalities associated with described algorithms, methods, functions, processes, flows, and procedures, according to an implementation of the present disclosure. In the illustrated implementation, System 300 includes a Computer 302 and a Network 330.

The illustrated Computer 302 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the Computer 302 can include an input device, such as a keypad, keyboard, touch screen, another input device, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as a client, network component, a server, a database or another persistency, another role, or a combination of roles for performing the subject matter described in the present disclosure. The illustrated Computer 302 is communicably coupled with a Network 330. In some implementations, one or more components of the Computer 302 can be configured to operate within an environment, including cloud-computing-based, local, global, another environment, or a combination of environments.

At a high level, the Computer 302 is an electronic computing device operable to receive, transmit, process, store, or manage data and information associated with the described subject matter. According to some implementations, the Computer 302 can also include or be communicably coupled with a server, including an application server, e-mail server, web server, caching server, streaming data server, another server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302. In an example, Interface 304 can include USB, FIREWIRE, or WIFI technologies.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory, conventional, or another type of database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

Described implementations of the subject matter can include one or more features, alone or in combination.

For example, in a first implementation, a digitally-based, thermal imaging device, comprising: a tube-shaped body, containing within: a receiving optical sensor; a viewing computer display; and a rechargeable battery 114; a user-replaceable battery; an integrated control mechanism turret; and a data transfer interface turret.

The foregoing and other described implementations can each, optionally, include one or more of the following features:

A first feature, combinable with any of the following features, wherein the user-replaceable battery is situated within a battery turret that is coupled to the tube-shaped body and comprises a removable cap.

A second feature, combinable with any of the previous or following features, wherein the integrated control mechanism turret is of a push/rotary-type.

A third feature, combinable with any of the previous or following features, wherein the data transfer interface turret comprises a removable cap.

A fourth feature, combinable with any of the previous or following features, wherein the data transfer interface turret comprises a universal serial bus and WIFI interface.

A fifth feature, combinable with any of the previous or following features, wherein the tube-shaped body is configured to be separable to replace the wherein the rechargeable battery within the tube-shaped body.

A sixth feature, combinable with any of the previous or following features, wherein the tube-shaped body is configured to be separable by unscrewing two pieces of the tube-shaped body.

For example, in a second implementation, a digitally-based, thermal imaging device, comprising: a tube-shaped body, containing within: receiving optics; a receiving optical sensor; processing electronics; a viewing computer display; viewing optics; and a rechargeable battery 114; a battery turret coupled to the tube-shaped body and configured to contain a user-replaceable battery; an integrated control mechanism turret; and a data transfer interface turret.

The foregoing and other described implementations can each, optionally, include one or more of the following features:

A first feature, combinable with any of the following features, wherein the battery turret comprises a removable cap.

A second feature, combinable with any of the previous or following features, wherein the integrated control mechanism turret is of a push/rotary-type.

A third feature, combinable with any of the previous or following features, wherein the data transfer interface turret comprises a removable cap.

A fourth feature, combinable with any of the previous or following features, wherein the data transfer interface turret comprises a universal serial bus and WIFI interface.

A fifth feature, combinable with any of the previous or following features, wherein the tube-shaped body is configured to be separable to replace the wherein the rechargeable battery within the tube-shaped body.

A sixth feature, combinable with any of the previous or following features, wherein the tube-shaped body is configured to be separable by unscrewing two pieces of the tube-shaped body.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special purpose logic circuitry, for example, a central processing unit (CPU), a field programmable gate array (FPGA), or an application-specific integrated circuit (ASIC). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A digitally-based, thermal imaging device, comprising:
a tube-shaped body, containing within:
a receiving optical sensor;
a viewing computer display; and
a rechargeable battery 114;
a user-replaceable battery;
an integrated control mechanism turret; and
a data transfer interface turret.

2. The digitally-based, thermal imaging device of claim 1, wherein the user-replaceable battery is situated within a battery turret that is coupled to the tube-shaped body and comprises a removable cap.

3. The digitally-based, thermal imaging device of claim 1, wherein the integrated control mechanism turret is of a push/rotary-type.

4. The digitally-based, thermal imaging device of claim 1, wherein the data transfer interface turret comprises a removable cap.

5. The digitally-based, thermal imaging device of claim 1, wherein the data transfer interface turret comprises a universal serial bus and WIFI interface.

6. The digitally-based, thermal imaging device of claim 1, wherein the tube-shaped body is configured to be separable to replace the wherein the rechargeable battery within the tube-shaped body.

7. The digitally-based, thermal imaging device of claim 1, wherein the tube-shaped body is configured to be separable by unscrewing two pieces of the tube-shaped body.

8. A digitally-based, thermal imaging device, comprising:
a tube-shaped body, containing within:
receiving optics;
a receiving optical sensor;
processing electronics;
a viewing computer display;
viewing optics; and
a rechargeable battery 114;
a battery turret coupled to the tube-shaped body and configured to contain a user-replaceable battery;
an integrated control mechanism turret; and
a data transfer interface turret.

9. The digitally-based, thermal imaging device of claim 8, wherein the battery turret comprises a removable cap.

10. The digitally-based, thermal imaging device of claim 8, wherein the integrated control mechanism turret is of a push/rotary-type.

11. The digitally-based, thermal imaging device of claim 8, wherein the data transfer interface turret comprises a removable cap.

12. The digitally-based, thermal imaging device of claim 8, wherein the data transfer interface turret comprises a universal serial bus and WIFI interface.

13. The digitally-based, thermal imaging device of claim 8, wherein the tube-shaped body is configured to be separable to replace the wherein the rechargeable battery within the tube-shaped body.

14. The digitally-based, thermal imaging device of claim 8, wherein the tube-shaped body is configured to be separable by unscrewing two pieces of the tube-shaped body.
